(19) United States
(12) Patent Application Publication
(10) Pub. No.: US 2026/0131262 A1
(43) Pub. Date: May 14, 2026

(54) PERMEABLE INFILTRATION FIELD FORMS AND METHODS OF USE

(71) Applicants: David A. Potts, Lyme, CT (US); Daniel Borkowski, Old Lyme, CT (US); David Jewett, Meriden, CT (US); Paul Tarko, Windsor Locks, CT (US)

(72) Inventors: David A. Potts, Lyme, CT (US); Daniel Borkowski, Old Lyme, CT (US); David Jewett, Meriden, CT (US); Paul Tarko, Windsor Locks, CT (US)

(73) Assignee: Geomatrix, LLC, Old Saybrook, CT (US)

(21) Appl. No.: 19/334,417

(22) Filed: Sep. 19, 2025

Related U.S. Application Data
(60) Provisional application No. 63/719,868, filed on Nov. 13, 2024.

(51) Int. Cl. B01D 24/02

(52) U.S. Cl. CPC B01D 24/02; B01D 2101/04

(57) ABSTRACT

Permeable forms used in wastewater infiltration fields are described and taught along with methods of use. The forms contain one or more sides that are permeable to water to allow water to pass though the permeable side of the form and allow water to pass from inside of an infiltration field to outside of an infiltration field. The forms are suitable to remain in the ground after installation of the infiltration field.

### TECHNICAL FIELD

A Permeable form for water infiltration field and processes of use are provided and described. More specifically, a form used during installation or repair or change of an infiltration field remains in place after installation or repair or change of the infiltration field where the form comprises a permeable surface having a porosity permitting the passage of water through the permeable surface in or out of a distribution media or a treatment media.

### BACKGROUND

Water having various sources including septic wastewater, storm water, and process water (all of which may herein be collectively referred to as “water”) may be treated via a water treatment system. Water treatment systems can vary in size and scope. They can be sized for treating large amounts of water from a municipality or other large cumulative systems for benefitting many residences, businesses, and industrial facilities serviced by the municipality. Water treatment systems can also be sized for treating smaller amounts of water from local and nearby single or multiple residences and commercial facilities.

Wastewater treatment systems can comprise various components, some or all of which may be installed partially or fully below ground surface. These components can include treatment tanks, infiltration fields, junction boxes, active pumps, active blowers, vents, and connecting conduits therebetween.

In the various applications, a water treatment system may receive water to be treated from an upstream source and may pass that water through the system and ultimately discharge that water to the environment via an infiltration field or other end of line discharge configuration.

Various techniques have been employed for infiltration fields including large below ground hollow dry wells, hollow plastic chambers, bundled cuspated layered materials, and cuspated material wrapped in geotextile. In each instance water being treated enters an internal area of the infiltration field and passes through at least a portion of this internal area of the infiltration field to then exit the internal area of the infiltration field to be discharged into materials surrounding the infiltration field.

### BRIEF DESCRIPTION OF THE DRAWINGS

FIG. 1 illustrates a side sectional view of a portion of sides of a permeable infiltration field form as may be employed in some embodiments.

FIGS. 2A-2C illustrate views of various possible permeability configurations of a side of the permeable infiltration field form as may be employed in FIG. 1 or other embodiment.

FIG. 3 illustrates a side sectional view of stacked permeable infiltration field forms as may be employed in embodiments.

FIG. 4 illustrates a side sectional view of a permeable infiltration field form with aggregate, geotextile fabric, and dosing pipe dosing conduits, as may be employed in some embodiments.

FIG. 5 illustrates a top down view and side view of a permeable infiltration field form as may be employed in some embodiments.

FIG. 6 illustrates a side view of a permeable infiltration field form as may be employed in some embodiments.

FIG. 7 illustrates a top down perspective view of a permeable infiltration field form as may be employed in some embodiments.

FIG. 8 illustrates a top down perspective view of a permeable infiltration field form in a nested configuration as may be employed in some embodiments.

FIG. 9 illustrates a perspective view of a permeable infiltration field form in a nested configuration as may be employed in some embodiments.

FIG. 10 illustrates a perspective view of a serpentine infiltration field form as may be employed in some embodiments.

### DETAILED DESCRIPTION

Embodiments may comprise forms having one or more permeable sides whereby the forms may be configured to be placed and then, after placement, filled with aggregate or other placeable material, and remain for use as part of an infiltration field or remain for use in other water system applications. Water to be handled may be directed into the installed and filled permeable form (“form”) such that the water reaches the aggregate or other fill material shaped by the form. The water may reach the installed forms via a dosing pipe or other dosing conduit system. The water may then pass through one or more surfaces of the form into surrounding soil or other surrounding material. Embodiments may be used with water treatment systems as well as storm water systems. In applications, the form may serve to define one or more borders for the aggregate or other fill material and may also allow water flowed into the aggregate or other fill material to pass though the aggregate or other fill material and through one or more permeable sides of the form and into the surroundings. The permeable side may be a top, bottom, lower surface but not necessarily the bottom or side of the form, and the form may comprise various materials. These materials may comprise metal or polymer or other prolonged duration materials as compared to cardboard, which is considered a biodegradable short duration material. Combinations of the metal or polymer or other prolonged duration material, i.e., composite material(s), may also be employed in embodiments. The permeable sides may be shaped in the form of a uniform or nonuniform screen, mesh, lattice, filter, patterned filter, basket weave, etc. or the like. One or more sides of the forms may be solid, i.e., nonpermeable, while one or more sides of the forms may have a portion that is permeable so as to allow water to flow through this permeable portion of the form. The permeability of the form sides may be determined so as to retard travel of internal or external materials to pass into or out of a permeable side wall but to allow water to pass through the same sidewall.

In some embodiments, the sides of forms may be covered with a geotextile material or may not be covered with a geotextile material in embodiments. The geotextile material may serve to retard the passage of treatment media or distribution media or other material into or out of the form. Geotextile material may be placed outside of the permeable forms and may cover or be underneath dosing conduits, such as dosing pipes, feeding an installed permeable form water. Dosing conduits of embodiments may comprise various designs and features and may include pressurized and unpressurized conduits. The conduits may be PVC, ABS, copper, or other common piping materials. The conduits may also be concrete channels, concrete pipes, and other materials as well. The dosing conduits may traverse various portions of the installed forms. They may be placed atop or beside some of an installed form as well as across an entire length of an installed form and other configurations as well.

The forms may have various configurations and may have upright and/or angled sides. One or more angled side walls may be provided to promote nested stacking of forms into one another. The angling of one or more sides walls may also be beneficial to promote passage of water from inside the form, downwardly and through an angled side wall of the form. FIG. 4, for example, illustrates how water may pass from within the aggregate or other internal material of a form, through a side, and into surrounding material. The water exiting the form and associated aggregate or other internal material is allowed to flow by gravity and capillarity through a different hydraulic window, than if the sidewall was vertical. In other words, when angled side walls are employed, e.g., nonvertical side walls, water may be flowed under the flow of a different gravity force vector through the nonvertical angled side walls than if the side wall was purely vertical. Also, when considering an angled side wall and water passing though the side wall, an orifice at a higher elevation inherently discharges water before an orifice at a lower elevation, increasing hydraulic saturation as a larger portion of the receiving media can become readily reachable.

In embodiments, the sidewalls, top, and bottom, may be considered tough or rugged such that they can generally hold their shape during transport, placement, filling, and while in use. Once backfilled in place, surrounding soil or other material may provide support for the forms and aggregate or other internal material as well.

The orifice configuration (e.g., shape, sizing, and spacing) of the permeable sides may inhibit clogging and may have a porosity at least equal to or greater than internal media such as stone aggregate, plastic aggregate, or other internal material, located in the forms. By having a somewhat equivalent or greater porosity, water may flow unrestricted through aggregate distribution media or other internal material, through the sides, and out of the forms when installed. Exemplary aggregate distribution media material may include stone or gravel having various sieve ratings, plastic chips, plastic pieces, and other materials having zero or negative buoyancy in water, which means the aggregate distribution media will not float in water. Aggregate distribution media that does not float in water is employed in embodiments so that the aggregate distribution media is biased to stay in place during subsurface high water events. These denser materials are also less prone to shifting, compaction and loss of void space.

Embodiments may provide advantages other than the passage of water through one or more sides of a form. For example, metal forms of embodiments are preferable to cardboard as cardboard alone is not sufficiently rigid to allow filling with stone prior to filling sand around the form during installation. Cardboard is understood to require concurrently filling inside of the form with stone and outside of the form with sand, so as to preserve the specific shape and not lose the critical geometry that creates the high level of treatment and infiltration efficiency. This concurrent filling requirement is considered detrimental and time consuming. Comparatively, embodiments may employ metal forms, or composite forms, or other rugged forms, which may be filled first in the form and then second backfilled around the form, or vice versa, in some embodiments.

Cardboard alone is considered not sufficiently rigid and is inaccurate for shaping sand and stone into discrete properly shaped fingers to facilitate desired air and water interactions. It is further understood that cardboard shifts, e.g., “floats” when heavier aggregate is placed next to it, in other words, it is understood that cardboard drifts laterally when aggregate acts against the cardboard.

In some embodiments, a rigid form with sidewall permeability may be employed where the sidewall porosity is greater than or equal to washed ¼″-2″ stone and gravel (e.g., exemplary aggregate) at time of installation.

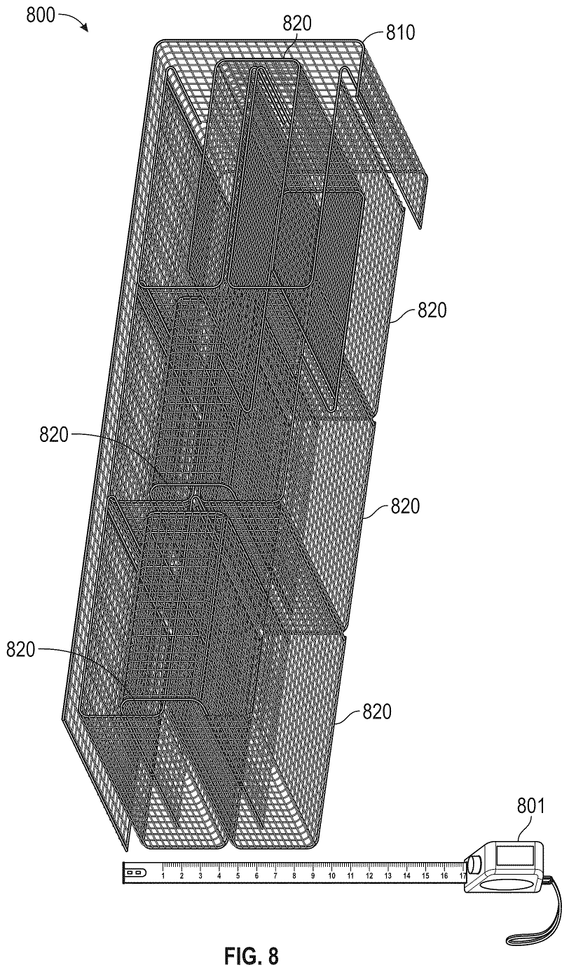

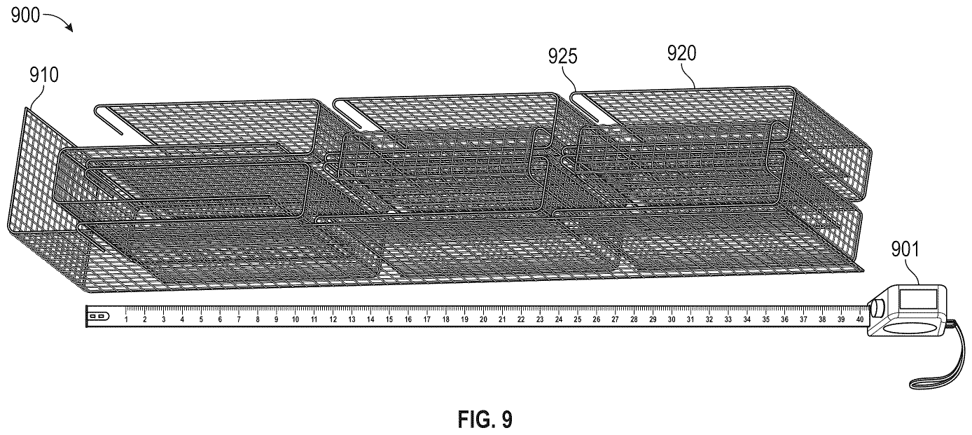

As noted above, in some embodiments, forms may be sized such that the forms are narrower at their base than at the top of their side walls. This angled side wall serves to allow water to infiltrate through the side walls under force of gravity in its own hydraulic window. The angled sides also provide stability and nested stackability for compact shipment. Forms may be nestable in other configurations as well. For example, FIGS. 8-9 show how forms may be configured to be nestable and compacted for transport and then finally assembled at an installation site for subsequent placement and filling in and around with distribution media and/or treatment media.

Permeable metallic forms are preferable to solid wall cardboard forms, which inhibit infiltration of wastewater and do not breakdown completely underground. This failure of complete breakdown results in higher % of failing systems and cardboard enhances biomat clogging, which is not preferred. Cardboard forms are not suited to configuring with holes in that this significantly lessens the ability of the cardboard to hold a specific shape.

The presence of filter fabric capillarity in buried infiltration systems serve to hold water, inhibit oxygen transfer and result in clogging. Therefore, forms of embodiments may not employ filter fabric on one or more sides. FIG. 4, for example, shows how the filter fabric 415 (geotextile fabric) may be draped across the top of a filled form and down a portion of each side wall but may not cover an entire side wall or a bottom side of the forms.

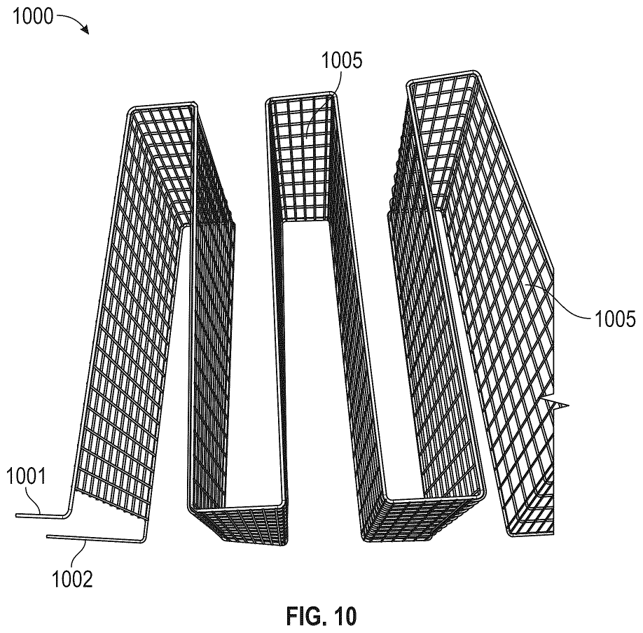

In some embodiments, the forms may be assembled in the field and may comprise stackable parts assembled with various attachment techniques. For example, side walls and bottoms of the form may be may be attached with locking or pivoting corners which may also be attached to lower sides or bottoms with the same locking or pivoting corners or with different attachment techniques. External connectors may be used to hold sides together. These may comprise metallic clips, polymer clips, zip ties, etc. More rigid connection techniques may also be employed. For example, soldering or welding may be employed to secure sides together in embodiments. The forms may also be longer sections that have been bent to form the finished shape with the two ends now secured together. For example, a rectangle or other polygon may be shaped by bending a linear screen material an then tack welding or zip tying the ends together so as to maintain the newly created closed shape. Fingers or other appendages may “hang” on other portions of the forms and may be better secured during the installation process. For example, an unassembled form, like that shown in FIG. 9 or 10, may be unpacked and then have its appendages hung from the side walls to create the desired final form shape. Once the final form shape is created the appendages may be further secured as described above. Filling may then take place.

Filling in around permeable forms may be accomplished with the use of custom lids, which cover portions not intended to receive media being placed. Then once the media to be placed is completed and reached a suitable level, a different custom lid may be employed to cover the recently filled areas, the cover slid over to cover an adjacent space or no lid may be employed to fill the remaining areas in and around the form with media.

Transportable plastic net tubes with light weight aggregate/packing peanuts do not allow for shapes other than cylinders, since the netting simply stretches to hold the aggregate. Also, the plastic netting without a rigid framework is limited to lighter weight aggregates so as not rip and tear nor are they capable of forming polygonal shapes. Comparatively, embodiments may employ planar side surfaces as well as high aspect shapes far better for wastewater treatment. For example, forms of embodiments may be employed with planar sides for forming the shapes of polygons with relatively narrow thicknesses and relatively tall heights. These aspect ratios may be three and ninety six (width/thickness to height ratio) and in this range as well in some embodiments. This thickness to height ratio is considered their aspect ratio and the identified ratio promotes filling and discharge of water from within the field form to outside of the field form.

Embodiments may comprise forms of various shapes and sizes and processes installing, deploying or employing these various forms. Moreover, complex shapes may be formed with the forms of embodiments. Serpentine and crenulated shapes may be formed by forms, for example. A form with a framework supporting the mesh can act to allow accurate shaping of complex shapes. For example, forms may be shaped as central rectangular channels with rectangular fingers. The side walls may be fairly vertical as well as angled as discussed herein. These forms may be stackable within one another in full or in part. In other words, a portion of a form may be stackable while other portions of a form may not be. In these instances, or in other instances the forms may be partially assembled upon arrival at a job site and may be further assembled with various connection techniques, includes those identified above. Different materials may be placed inside of and outside of the forms. The inside materials may be considered distribution media while the material outside the form may be considered treatment media. The distribution media may be the aggregate discussed above while the treatment media may be sand or other soil that permits passage of water to move away from the installed forms. The media inside the forms can also be utilized as treatment media.

In embodiments, the form stays in the ground after placement and backfill. The forms may comprise various materials, such as plastic, metal, fiberglass, and wood. The forms in some embodiments may be formed through injection molding. These may be a single molding as well as being assembled from multiple pieces. In embodiments, the forms may be rigid enough to shape aggregate being placed in the forms during installation with little to no additional external support. For example, a form may be placed in a hole or other target location and the aggregate may be placed in the form. Processes of installation may comprise excavating a hole, assembling the forms into a shape with an internal aggregate receiving area and an outside area. Placing geotextile on one or more surfaces of the form. Placing aggregate into the form. This may be done with or without applying a shield or cover outside of the form to limit the amount of aggregate that inadvertently is placed outside of the form while filling the form. Placing sand or other treatment media outside of the form. Distribution piping to channel water to the form or dosing piping to directly feed the form may be installed at various stages of this assembly of the forms. When completed, an installed form system that has been filled and backfilled will have piping to the form system for carrying water to the form. Distribution within an installed form system may be accomplished by various techniques. For example, a dosing conduit may be placed across portions of the form. Some embodiments may not employ such a dosing conduit and may use internal flow only for water to be distributed throughout the installed form. Dosing conduits may also feed only portions of the forms in some embodiments.

Embodiments may employ vertical, horizontal or angles spikes or stakes on their bottom, side walls or elsewhere in order to interact with underlying or nearby soil and sand to hold the form place. The subject forms are suitable for filling onsite and the associated rigors that are involved. Forms may also be prefilled and transported to the site.

As noted above, some embodiments may employ a cover for filling, where the cover has legs to support the cover during backfill and to inhibit crushing/deforming the form during filling and/or backfill. In some embodiments, the cover can allow filling aggregate inside a form but not allow aggregate to fill sand location positioned outside the form.

Treatment media may preferably be sand, stone, gravel or soil, perlite, biochar, peat, diatomaceous earth, or blends of these materials or other material having a porosity less than the porosity of any distribution media in an infiltration field. The treatment media may comprise or consist of a carbon source as well as an iron containing substance or a substance for adjusting alkalinity or ph. Iron shavings or another iron source may be used to bind phosphorus. Stone being employed may be limestone, which can provide ph adjustment. Carbon sources, which may be added to treatment media, or may be used as its own treatment media, may include food grade oils, sawdust, sugar, wood chips, molasses, and other carbon sources. When wood materials are blended into sand during construction, the carbon in the wood can be consumed over time. Carbon sources can be added to rejuvenate the treatment efficiency. Still further, access conduits may be used for connection to other treatment systems including denitrification systems and additional leaching components.

Compared to distribution media, treatment media, when placed, is preferably conducive to treatment of water received from a dosing pipe or distribution media or other conveyor of water. Treatment may occur within the treatment media itself as well as at infiltrative interfaces between the treatment media or distribution media and another material, such as surrounding soil or distribution media. Infiltration interfaces of infiltration surfaces may or may not employ geotextile fabric, such as filter fabric, or other geotextile material. Accordingly, treatment media, when placed, is preferably conducive to treatment of water received from a dosing conduit or distribution media or other water source. Leaching interfaces may or may not employ filter fabric or other geotextile material. The treatment media may comprise sand or soil or diatomaceous earth, or a carbon source, or other media capable of treating water. Some embodiments may employ non-sandy soil as a treatment media, while other leaching infiltration fields may employ sand as a treatment media. In embodiments, an exemplary multiple band infiltration field may employ sand as one treatment media, non-sandy soil as a second treatment media, stringy plastic mat as a first distribution media, and stone aggregate as a second treatment media. Other combinations of materials, for systems or methods employing layered capillary wetting, may also be used in embodiments.

Permeable infiltration field forms of embodiments may have different configurations, installation depths, sizes and features, including different combinations of the features shown herein. These configuration changes may include the design of and materials comprising the form sides themselves, as well as the materials comprising the treatment media, the materials comprising the distribution media, the installation depth of one or more infiltration fields, the height, width, or other dimension of the forms, and the materials, if any, comprising the permeable sides or other infiltration surfaces. For example, some infiltration fields of a system may employ non-sandy soil as a treatment media, while other leaching infiltration fields may employ sand as a treatment media. Likewise, the distribution media may be different between different structures of an infiltration field. Similarly, the distribution media may be different between different bands within a single infiltration structure having multiple nested bands of treatment media and distribution media.

Thus, for example, a system may have a first infiltration field formed with sand treatment media and stone aggregate distribution media, while a second infiltration field structure may have non-sandy treatment media and cuspated three-dimensional grid as a distribution media. Moreover, this first infiltration field may be adjacent to the second infiltration field and may be set multiple feet below the surface and/or the second infiltration field may be deeper than the first infiltration field and may even be below or directly below the first infiltration field. An infiltration field form may be vertically oriented. Vertically oriented should be understood to comprise when a height or depth is twice or more, greater than a width, of a measured infiltration form. In other words, vertically elongated means that a component or system has a height/depth to width aspect ratio of 2 or larger. This can include ratios of 2, 3, 4, 5, 10, 15, 20, 25, 30, 35, 40, 50, or 100 or more and intervening ratios as well. Horizontal layers of treatment media and/or distribution media may also be present in embodiments.

In embodiments, an exemplary multiple band infiltration field may employ sand as one treatment media, non-sandy soil as a second treatment media, stringy plastic mat as a first distribution media, and stone aggregate as a second distribution media. Other combinations, with and without leaching structures, and other materials may also be used in embodiments.

In some embodiments, the distribution media may preferably have a porosity that is greater than the treatment media. The increased porosity may provide for flow channels within the distribution media of an infiltration field. The flow channel may be the width of a band of distribution media. In other words, the thickness of a band of distribution media may allow water to flow within it and may be considered a flow channel. These flow channels may provide paths of less fluid resistance in which the water may pass in order to access a greater percentage of the infiltration field and the treatment media therein. The distribution media may include three-dimensional grids (e.g., cuspated panels, geogrid, Geomat™ brand geogrid, etc.), aggregate, stone aggregate, plastic aggregate, stringy fiber mat, as well as other materials, and combinations thereof. Exemplary three-dimensional grids include Enkadrain drainage system product No. 9120 from Colbond Inc., P.O. Box 1057, Enka, NC 28728; and the several geogrids named Grasspave2, Gravelpave2, Rainstore2, Slopetame2, Draincore2, Surefoot4, Rainstore3 from Invisible Structures, Inc., 1600 Jackson Street, Suite 310, Golden, CO 80401. Geomat™ brand geogrid should be considered a core of fused entangled filaments with a geotextile fabric bonded to one side.

Distribution media, when placed, is preferably highly permeable to water and structurally supportive. The treatment media may preferably be sand, or soil, perlite, biochar, peat, diatomaceous earth, or blends of these materials or other material having a porosity less than the porosity of the distribution media in the infiltration field. The treatment media may comprise or consist of a carbon source. Compared to distribution media, treatment media, when placed, is preferably conducive to treatment of water received from the dosing pipe or distribution media. This treatment may occur within the treatment media itself as well as at infiltrative interfaces between the treatment media or distribution media and another material, such as surrounding soil or distribution media. Infiltration interfaces of infiltration surfaces and/or nested infiltration surfaces may or may not employ geotextile fabric, such as filter fabric, or other geotextile material.

A band of either the treatment media or distribution media may be considered a three-dimensional volume comprising the width, height, and length of treatment media or distribution media, whether installed or prior to installation.

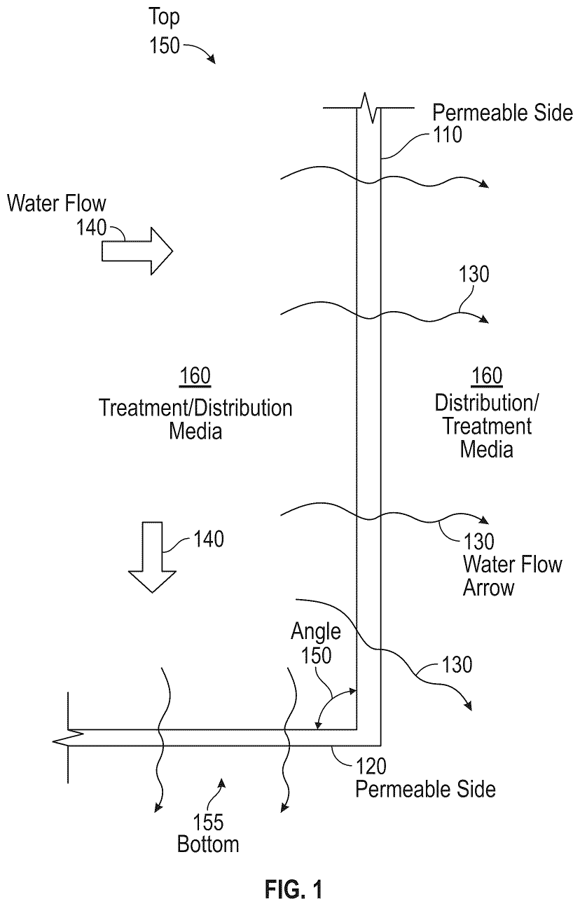

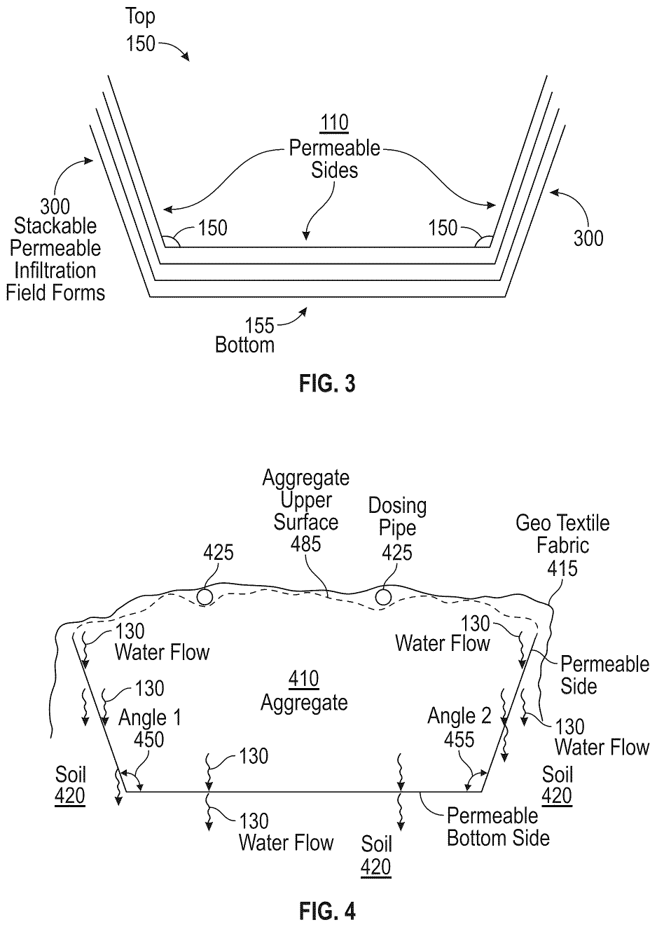

FIG. 1 illustrates a side sectional view of a portion of sides of a permeable infiltration field form as may be employed in some embodiments. This sectional view shows a permeable side 110 and a permeable side 120. The side 110 is positioned as a wall while the side 120 is positioned as a bottom. The bottom is also labelled 155 in FIG. 1. Treatment media/distribution media 160 may be located inside of an installed permeable form and outside of an installed permeable form as is shown in FIG. 1. Water may enter from the top 150 and may flow as shown by arrows 130 and 140. The water may be deposited by various means in installed embodiments, including from a dosing conduit traversing a majority of the installed form to a delivery conduit terminating near or within an installed form. The angle 150 may be 90° but may also be nonorthogonal. When angle 150 is greater than 90° the sides may promote nesting with other forms. For example, is the bottom and wall sides of a form meet at 100° this open angle can promote stacking of other forms within it. FIG. 3 shows an example of the stacked forms.

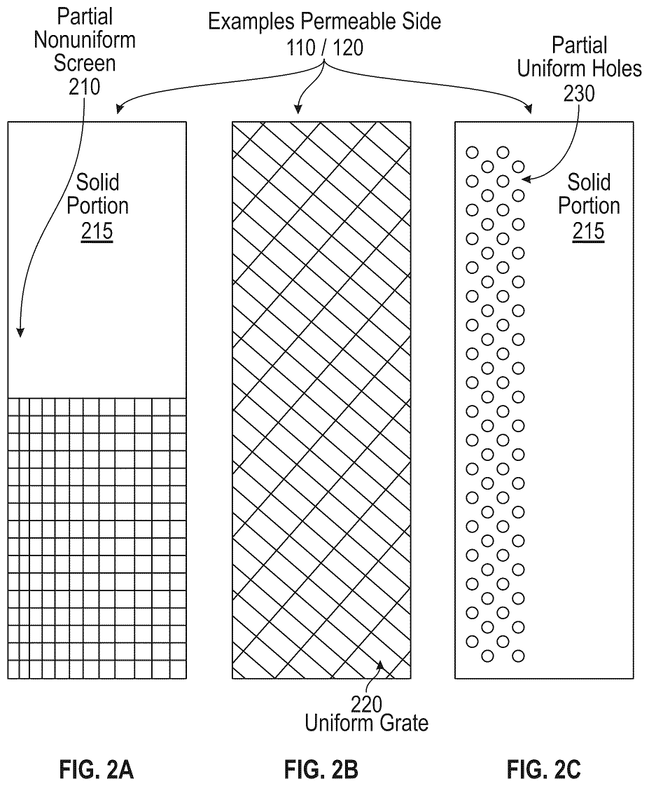

FIGS. 2A-2C illustrate views of various possible configurations of a side of the permeable infiltration field form as may be employed in FIG. 1 or other embodiment. These sides 110/120 may be walls or lower or bottom sides of form of embodiments. These sides may comprise various features, such as solid portions 215, partial uniform holes/passages 230, and uniform grates 220. Other configurations of the sides may also be employed. In embodiments, the porosity of the permeable sides may be equal to or greater than the porosity of distribution media located inside the form so as to promote water transport into and through the form and out to treatment media outside of the installed form.

FIG. 3 illustrates a side sectional view of permeable infiltration field forms as may be employed in embodiments. FIG. 3 shows how forms of embodiments may be stacked prior to installation. This stacking may occur for transport, for onsite space management, for consolidation, and for various other reasons as well. As can be seen, the slanted side walls provide for a nested configuration. As can also be seen in this sectional view, the side walls and bottom surface may each comprise permeable material. In some embodiments, one or more of the side walls or the bottom may not comprise a permeable material. Labelled in FIG. 3 are stacked forms 300, permeable sides 110, bottom 155, and top 150.

FIG. 4 illustrates a side sectional view of a permeable infiltration field form with aggregate, geotextile fabric, and dosing pipe dosing conduits, as may be employed in some embodiments. FIG. 4 shows how water can flow downward though the form. This embodiment has a permeable bottom side as well as permeable side walls. Angle 1 (450 ) and angle 2 (455) may be the same or may be different. These angles may be a few degrees from perpendicular, e.g., 89°-85° as well as larger, e.g., 75°-65°. As the larger angles as selected backfilling below the side walls may become more difficult and may be less preferred. However, different slope angle for the side walls can promote comparatively different flow rates though the side walls. The angle of the form sidewall can approximate the angle of repose of the sand that is utilized to surround the form. Labelled in FIG. 4 are dosing pipes 45, aggregate upper surface 485, geotextile fabric, water flow 130, soil 420, and aggregate 410.

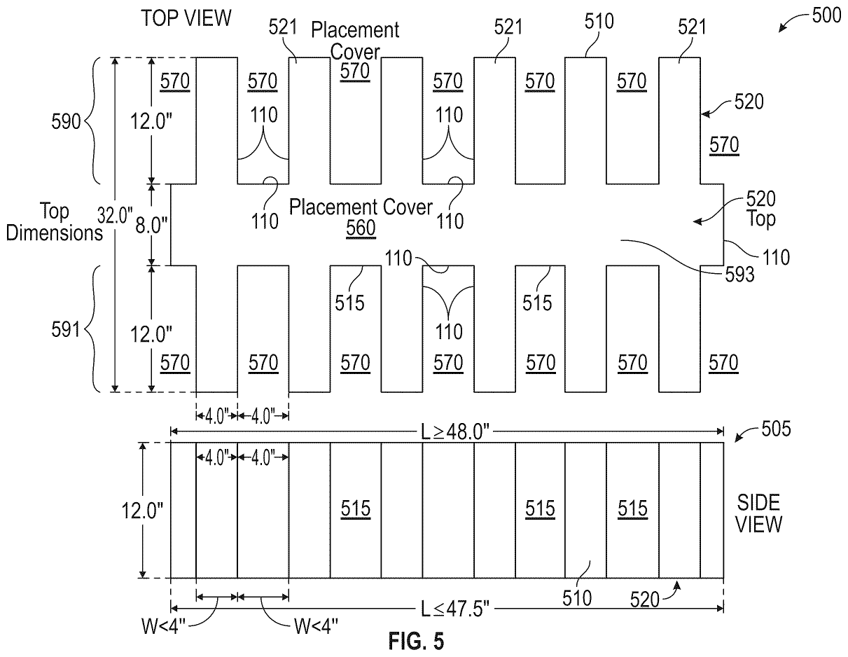

FIG. 5 illustrates a top down view and side view of a permeable infiltration field form as may be employed in some embodiments. The top down portion 500 of FIG. 5 shows that permeable forms of embodiments may comprise a channel with fingers extending from the channel. This top down portion also provides exemplary sizing for the form. However, other dimensions and shapes may also be employed in embodiments. The channel with extending finger design can provides for a suitable amount of infiltration interfaces between the form and the surrounding soil when the forms are installed. The channels can be centered as shown above but may be located in other locations as well. For example, on a single side with all the fingers extending outward in a single direction. The side view 505 of FIG. 5 shows that the top length of the form may be longer than the bottom length of the form. This difference in length results in the slope of the side walls identified above. During installation a placement cover may be located over areas 570 or 560 to promote efficient placement of media inside of or outside of the form. When a cover is placed over area 560, the central gallery and the fingers may be covered such that treatment media may be installed around the form. Comparatively, when a cover is placed over areas 570, the central gallery and fingers may be filled with distribution media and/or treatment media. Thus, embodiments may employ the selective use of covers to cover areas in and around the placed form such that areas to be filled are exposed and areas not to be filled are covered. In some embodiments, the form may simply comprise a crenulated form portion as is shown in FIG. 5. For example, the central gallery may not be bordered by a form and only the perimeter finger areas may have a form for shaping. Specifically, in FIG. 5, the 8″ portion of the form would not exist and the sections 590 and 591 could be spaced apart from each other at different distances because they were not attached via the central gallery 593. Side sections 515 may also be missing in some embodiments, whereby the fingers 521 would be placed apart from one another and not set by a particular connection 515 between each finger 521. Crenulated is understood as requiring right angles in the shape while serpentine is understood to be broader and not require the presence of perpendicular angles.

The dimensions shown in 505 of FIG. 5 show how a form may be larger on top than the bottom. Here the top of the form is shown as having a length greater than or equal to 48″ while the bottom is shown having a length less than or equal to 47.5″ Forms in embodiments may have several sizes and these dimensions are merely illustrative as the forms may be both larger and smaller. Also shown in FIG. 5 is how the width of the fingers at their top may be 4.0″ while the width of the fingers at their bottom may be less than 4.0″

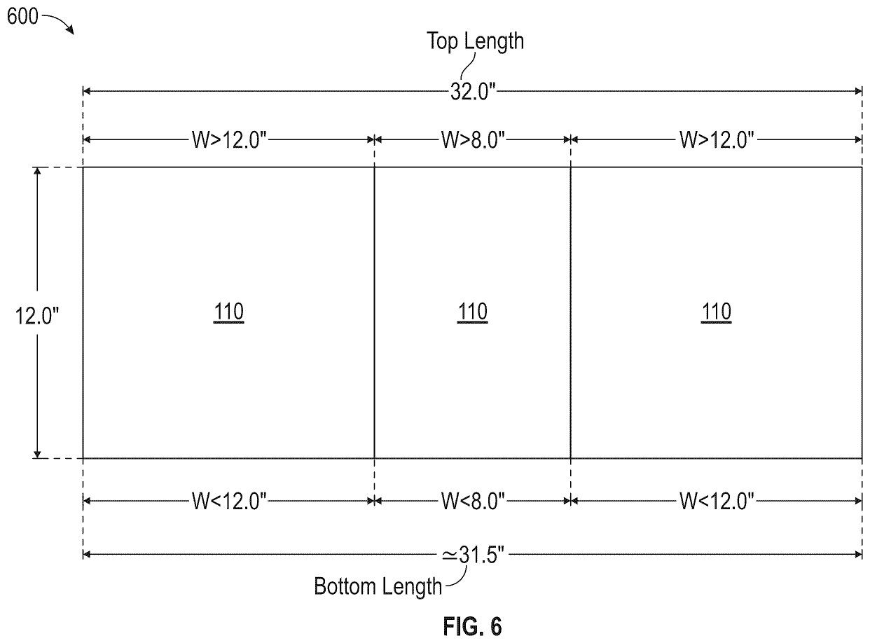

FIG. 6 illustrates a side view of a permeable infiltration field form 600 as may be employed in some embodiments. The above FIG. 6 is a side end view of the same permeable form identified above. As can be seen here as well, the top dimension is longer than the bottom dimension. Here, too, this dimensional difference provides that the side 110 are not purely perpendicular, and, instead are slightly sloped outwardly from the bottom surface of the form or the bottom of the side walls if the form does not have a bottom surface.

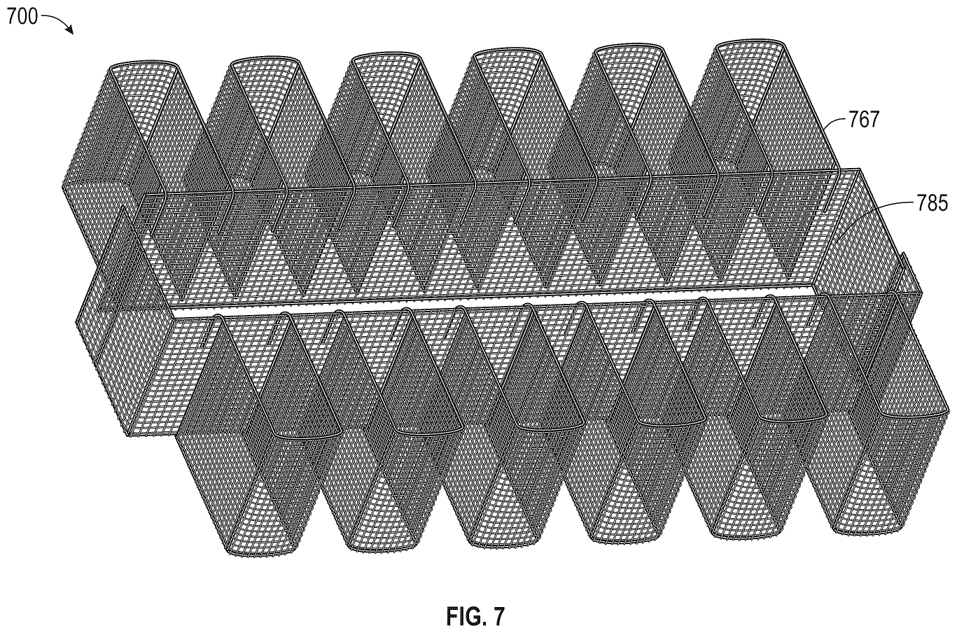

FIG. 7 illustrates a top down perspective view of a permeable infiltration field form 700 as may be employed in some embodiments. FIG. 7 demonstrates that in embodiments, end pieces and a central channel of a form need not be complete—as in FIG. 5. Embodiments may comprise two sets of fingers and these fingers may not be connected to central channels. In embodiments, a trench may be dug and can serve as a central area with form finger placed nearby or adjacent to delineate the infiltration field. FIG. 7 also illustrates that side baskets 767 may be hung from and connected to a central channel 785. Both the baskets and the central channel may be filled with media and covered for use as an infiltration field of a wastewater treatment system. In this Figure, there are no bottom surfaces or top surfaces. However, some forms of embodiments may have bottom and/or top surfaces as well. The forms of embodiments may also be constructed as a one piece or multiple piece form, with respect to total system length and/or unit width.

FIG. 8 illustrates a top down perspective view of a permeable infiltration field form 800 in a nested configuration as may be employed in some embodiments. FIG. 8 shows how the form may be collapsed prior to installation. This collapsed configuration can occupy less than a fully unpacked and assembled form. This reduced form factor can assist in making transport easier through smaller sizes and/or more economical. Forms and form components can be configured to also stack flat for shipping and storage efficiencies. The tape measure 801 provides scale for the form in FIG. 8. Embodiments may, however, be made at different sizes as well. The J-shaped gallery wall form is labelled as 810. This wall may be used to form a wall of a gallery of the form 800. U-shaped cages 820 are also shown in FIG. 8 in various orientations. These U-shaped cages 820 may be positioned adjacent to the wall form 810 and secured to the wall form 810 during installation in order to create a form factor similar to half of that shown in FIG. 7. In other words, the presence of a single J-shaped gallery wall in FIG. 8 and the numerous U-shaped cages 820 provide form materials to delineate half of the form in FIG. 7—either the left half of the form in FIG. 7 or the right half of the form in FIG. 7.

FIG. 9 also illustrates a perspective view of a permeable infiltration field form in a nested configuration as may be employed in some embodiments. Like FIG. 8, FIG. 9 also shows how the form may be collapsed prior to installation. This collapsed configuration can occupy less than a fully unpacked and assembled form. This reduced form factor can assist in making transport easier through smaller sizes and/or more economical. Forms and form components can be configured to also stack flat for shipping and storage efficiencies. The tape measure 901 provides insight into the size of the form in FIG. 9. However, as mentioned above, embodiments may be made in different sizes, both larger and smaller than that shown in FIG. 9. The gallery wall 910 in FIG. 9 is an L-Shape and the cages 920 are shown with connection hooks 925. These connection hook 925 may be hung over the gallery wall 910 to allow the cages 920 to protrude out from the gallery wall much like what is shown in, for example FIG. 7.

FIG. 10 illustrates a perspective view of a serpentine infiltration field form 1000 as may be employed in some embodiments. A tope wire 1001 and bottom wire 1002 may be held apart by a webbing material 1005 and the wires may be bent back and forth to create a crenulated shape. This form 1000 may be placed adjacent to a central channel that has been dug and filled with aggregate distribution media. The form may then be filled with distribution media on one side (e.g., the inside) and treatment media on the other side (e.g., the outside) and the form may be left in place in this as well as in other embodiments described herein or used elsewhere. The form and media created may be considered permeable sided leaching fingers and plastic netting may be used as the webbing 1005 between top wire and bottom wire. Upon backfilling, embodiments may be covered with a geotextile fabric and a dosing conduit for feeding water to the installed form and media. During installation, as with other embodiments, a cover may be employed to help with placement of stone and sand in different steps during installation. Straight wire may be threaded with the webbing material and then bent to the desired shape. Clips or other connectors may be employed to hold the wire and webbing together. The webbing may have passages sized to retain ½ inch stone media or sized to retain other aggregate sizes.

Embodiments may comprise various combinations of the features described herein and may also include various other features consistent with the teachings provided herein as well. Processes may use features from different embodiments described herein and in different orders or sequences. In some embodiments a wastewater treatment system may comprise a wastewater treatment tank comprising an inlet and an outlet, where the tank may have outer side surfaces and an outer bottom surface, the outer side surfaces may each have a height. This tank may be located upstream of an infiltration field as taught herein and may supply water to the infiltration field. Alternatively, the permeable forms may be place around the perimeter of a treatment tank and the infiltration form constructed around one or more sides of the treatment tank.

Some embodiments may comprise using the processes, systems, articles of manufacture, or apparatus with or in wastewater systems that comprise: a processing/treatment vessel; a distribution system; and an infiltration system comprising an infiltration field, monitoring ports, and carbon addition ports. Some embodiments may comprise using the processes, systems, articles of manufacture, or apparatus with or in infiltration systems comprising infiltration fields comprised of stone, sand, hollow structures, man-made materials and/or synthetic media including geotextiles. Some embodiments may comprise using the processes, systems, articles of manufacture, or apparatus with or in water systems installed directly in native or imported soils. Some embodiments may comprise using the processes, systems, articles of manufacture, or apparatus with or in wastewater systems that include a secondary treatment vessel, such as but not limited to, a treatment unit. Some embodiments may comprise using the processes, systems, articles of manufacture, or apparatus with or in wastewater infiltration field(s) with a surface area to void space ratio of approximately <0.5. Some embodiments may comprise using the processes, systems, articles of manufacture, or apparatus with or in wastewater infiltration field(s). Some embodiments may comprise using the processes, systems, articles of manufacture, or apparatus with or in wastewater treatment systems that may be surrounded by the following soils:
Sands: silt+(1.5*clay)<15%
Loamy sands: silt+1.5*clay>=15% and silt+2*clay<30%
Sandy loams: clay>=7% and clay<20% and sand>52% and silt+2*clay>=30% OR clay<7% and silt<50% and silt+2*clay>=30%)
Loam: clay>=7% and clay<27% and silt>=28% and silt<50% and sand<=52%
Silt Loam: silt>=50% and clay>=12% and clay<27% OR silt>=50% and silt<80% and clay<12%
Silt: silt>=80% and clay<12%
Sandy Clay Loam: clay>=20% and clay<35% and silt<28% and sand>45%
Clay Loam: clay>=27% and clay<40% and sand>20% and sand<=45%
Silty Clay Loam: clay>=27% and clay<40% and sand<=20%
Sandy Clay: clay>=35% and sand>45%
Silty Clay: clay>=40% and silt>=40%
Clay: clay>=40% and sand<=45% and silt<40%

Some embodiments may comprise using the processes, systems, articles of manufacture, or apparatus with or in wastewater systems that have stone, cobbles, gravel, ledge, bedrock, or soil parent material as the native material surrounding the system. Some embodiments may comprise using the processes, systems, articles of manufacture, or apparatus with or in wastewater systems that have engineered media, such as specified sand or gravel/stone, as the material surrounding the system. Some embodiments may comprise using the processes, systems, articles of manufacture, or apparatus with or in wastewater systems that include passive remediation infrastructure including, but not limited to, a constructed wetland, sand filters, gravel filters, waste stabilizing pond/lagoon, collection basin, rain garden, retention/detention areas, vegetated or dry swales, or underground detention systems. Some embodiments may comprise using the processes, systems, articles of manufacture, or apparatus with or in wastewater systems that include vegetation pollutant removal, such as, but not limited to, rain gardens, bioswales, and evapotranspiration systems driven by such species as Salix or Phragmites. Some embodiments may comprise using the processes, systems, articles of manufacture, or apparatus with or in wastewater systems that are covered with sand, imported or native soil. Some embodiments may comprise using the processes, systems, articles of manufacture, or apparatus with or in wastewater systems that are covered with permeable or impermeable asphalt/pavement. Some embodiments may comprise using the processes, systems, articles of manufacture, or apparatus with or in wastewater systems that open to the atmosphere. Some embodiments may comprise using the processes, systems, articles of manufacture, or apparatus with or in wastewater systems that are located above grade.

Some embodiments may comprise using the processes, systems, articles of manufacture, or apparatus with or in wastewater systems that serve single residences, multi-family residences, commercial businesses, public organizations/property, private organizations/property, government buildings, and any other situation where onsite wastewater treatment is used.

Some embodiments may comprise using the processes, systems, articles of manufacture, or apparatus with or in community based onsite wastewater treatment systems and any soil or water-based treatment systems serving as intermediate or final treatment or dispersal for wastewater treatment plants.

Some embodiments may comprise using the processes, systems, articles of manufacture, or apparatus with or in systems that employ a geotextile fabric within and/or around the form. The geotextile fabric may stabilize the sediment during treatment to avoid soil stratification by particle size.

Embodiments may be employed when a system is restricted or failing to treat and disperse wastewater. Embodiments may be employed when a system is overloaded with wastewater/stormwater and/or organic matter, causing low levels of oxygen within an infiltration field (which may occur either or both because microbial decomposition of organic matter consumes oxygen and because the oxygen concentrations in water are many thousands of times lower than oxygen concentrations in air). These situations may occur when a system is heavily used, the infiltration field is relatively undersized, or if there is an addition of materials to the system that are noncompatible with treatment in the infiltration system. Embodiments may be employed when a system is operating normally, or close to normally, and it is desirable to inhibit or prevent restriction or failing.

Embodiments may comprise a process of forming a water infiltration field where the process comprises providing a permeable form, the permeable form comprising a plurality of upright sides, the upright sides shaped to separate material placed on opposite faces of the upright side, the upright sides comprising a metal or a plastic or both, at least one of the plurality of upright sides comprising a screen or other permeable surface, the permeable surface being permeable to water; and placing the permeable form at an installation area; and placing aggregate that has a specific gravity greater than 1 in the installation area; and leaving the permeable form and the aggregate at the installation area to receive water, the received water passing within the aggregate and infiltrating out through the permeable surface of the form and to media not within the form.

In some embodiments, the installation area may be an excavation and the permeable form may be in fluid communication with a dosing pipe, the dosing pipe coupled to a supply of wastewater to be discharged into the permeable form. In some embodiments, the plurality of upright sides may contact each other at an angle. In some embodiments, a plurality of upright sides may define a crenulated line and the plurality of upright sides may contact each other at a perpendicular, acute, or obtuse angle. In some embodiments, the plurality of upright sides may define at least one U-Shaped cage. In some embodiments, the permeable form may comprise a gallery, the gallery bordered by two or more sides, wherein at one of the two or more sides comprises a U-Shaped cage that may be hanging by a hook from a side of the gallery. In some embodiments, a permeable surface may have a first porosity to water and aggregate may have a second porosity to water, wherein, the first porosity is at least equal to or greater than the second porosity. In some embodiments, a first side and a second side of a plurality of sides of a permeable form may each have a top and a bottom and a spacing between the top of the first side and the second side is greater than a spacing between a bottom of the first side and the second side. In some embodiments, a geotextile fabric may be placed over the permeable form after placing aggregate into the permeable form; the permeable form may be in the shape of a polygon; and each of the plurality of upright sides may comprise a screen or other permeable surface permeable to water.

Some embodiments may comprise a water infiltration field comprising a first permeable form comprising a first, second, and third water permeable side, the first side connected to the second side and the second side connected to the third side, wherein each of the sides may be planar and may be made from metal construction or may be made from polymer construction. In some embodiments, a first permeable form may have an open top sized to accept aggregate through the open top and into an area defined by first, second, and third permeable sides and the first, second, and third water permeable sides may have an upright orientation. Some embodiments may comprise a water conduit in fluid communication with the first permeable form and some may have first, second, and third permeable sides forming a u-shape. In some embodiments, a first permeable form may comprise a fourth, fifth, and sixth water permeable side, the fourth side connected to the fifth side and the fifth side connected to the sixth side, wherein each of the sides may be planar and may be made from metal construction or are made from polymer construction. In some embodiments, a first permeable form may have an open top sized to accept aggregate through the open top and into a first area defined by the first, second, and third permeable sides and into a second area defined by the fourth, fifth, and sixth permeable sides, and, in some embodiments, the fourth, fifth, and sixth, water permeable sides of the first permeable form may have an upright or even perpendicular orientation. In some embodiments, a second permeable form may be included and comprise first, second, and third water permeable sides with the first side connected to the second side and the second side connected to the third side and wherein, each of the sides may be planar and may be made from metal construction or are made from polymer. In some embodiments a second permeable form may have an open top sized to accept aggregate through the open top and into an area defined by the first, second, and third permeable sides, and the first, second, and third water permeable sides may have an upright orientation.

In some embodiments, a shape of a first permeable form mimics a shape of a second permeable form. In some embodiments, a first permeable form may be sized and shaped to be stackable within a second permeable form. In some embodiments, an upright orientation is perfectly vertical while in other embodiments, an upright orientation is not perfectly vertical.

The preceding detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” of “in embodiments” do not necessarily refer to the same embodiment. Particular features, structures, or characteristics may be combined in any suitable manner consistent with this disclosure.

While embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention. Likewise, above embodiments may be combined partially or fully in various ways without departing from the scope of the invention.

The terminology used herein is for the purpose of describing particular embodiments only and is not intended to be limiting of the invention. As used herein, the singular forms “a,” “an” and “the” are intended to include plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “about” or “approximately” in reference to a recited numeric value, including for example, whole numbers, fractions, and/or percentages, generally indicates that the recited numeric value encompasses a range of numerical values (e.g., +/−5 % to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of ranges of values herein are merely intended to serve as a shorthand method of referring individually to each separate value falling within the range, unless otherwise indicated herein, and each separate value is incorporated into the specification as if it were individually recited herein.

“First,” “Second,” etc. As used herein, these terms are used as labels for nouns that they precede, and do not imply any type of ordering (e.g., spatial, temporal, logical, etc.). For example, reference to a “first” item does not necessarily imply that this item is the item in a sequence; instead, the term “first” is used to differentiate this item from another item (e.g., a “second” item).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The corresponding structures, material, acts, and equivalents of any means or steps plus function elements in the claims are intended to include any structure, material or act for performing the function in combination with other claimed elements. The description of certain embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A process of forming a water infiltration field, the process comprising:
providing a permeable form, the permeable form comprising a plurality of upright sides, the upright sides shaped to separate material placed on opposite faces of the upright side, the upright sides comprising a metal or a plastic or both, at least one of the plurality of upright sides comprising a screen or other permeable surface, the permeable surface being permeable to water;
placing the permeable form at an installation area;
placing aggregate that has a specific gravity greater than 1 in the installation area;
and leaving the permeable form and the aggregate at the installation area to receive water, the received water passing within the aggregate and infiltrating out through the permeable surface of the form and to media not within the form.

2. The process of claim 1 wherein the installation area is an excavation and wherein the permeable form is in fluid communication with a dosing pipe, the dosing pipe coupled to a supply of wastewater to be discharged into the permeable form.

3. The process of claim 1 wherein the plurality of upright sides contact each other at an angle.

4. The process of claim 1 wherein the plurality of upright sides define a crenulated line.

5. The process of claim 1 wherein the plurality of upright sides contact each other at a perpendicular, acute, or obtuse angle.

6. The process of claim 1 wherein the plurality of upright sides define at least one U-Shaped cage.

7. The process of claim 1 wherein the permeable form comprises a gallery, the gallery bordered by two or more sides, wherein at one of the two or more sides comprises a U-Shaped cage hanging by a hook from a side of the gallery.

8. The process of claim 1 wherein the permeable surface has a first porosity to water and the aggregate has a second porosity to water and, wherein, the first porosity is at least equal to or greater than the second porosity.

9. The process of claim 1 wherein first side and a second side of the plurality of sides of the permeable form each have a top and a bottom and wherein a spacing between the top of the first side and the second side is greater than a spacing between a bottom of the first side and the second side.

10. The process of claim 1 further comprising placing a geotextile fabric over the permeable form after placing aggregate into the permeable form, wherein the permeable form is in the shape of a polygon, and wherein each of the plurality of upright sides comprises a screen or other permeable surface, the permeable surfaces being permeable to water.

11. A water infiltration field comprising:
a first permeable form comprising a first, second, and third water permeable side, the first side connected to the second side and the second side connected to the third side, wherein each of the sides are planar and are made from metal construction or are made from polymer,
wherein the first permeable form has an open top sized to accept aggregate through the open top and into an area defined by the first, second, and third permeable sides, and
wherein the first, second, and third water permeable sides have an upright orientation.

12. The water infiltration field of claim 11 further comprising a water conduit in fluid communication with the first permeable form.

13. The water infiltration field of claim 11 wherein the first, second, and third permeable sides form a serpentine shape.

14. The water infiltration field of claim 11 wherein the first permeable form further comprises a fourth, fifth, and sixth water permeable side, the fourth side connected to the fifth side and the fifth side connected to the sixth side, wherein each of the sides are planar and are made from metal construction or are made from polymer,
wherein the first permeable form has an open top sized to accept aggregate through the open top and into a first area defined by the first, second, and third permeable sides and into a second area defined by the fourth, fifth, and sixth permeable sides, and
wherein the fourth, fifth, and sixth, water permeable sides of the first permeable form have an upright orientation.

15. The water infiltration field of claim 11 further comprising
a second permeable form comprising a first, second, and third water permeable side, the first side connected to the second side and the second side connected to the third side, wherein each of the sides are planar and are made from metal construction or are made from polymer,
wherein the second permeable form has an open top sized to accept aggregate through the open top and into an area defined by the first, second, and third permeable sides, and
wherein the first, second, and third water permeable sides have an upright orientation.

16. The water infiltration field of claim 15 wherein a shape of the first permeable form mimics a shape of the second permeable form.

17. The water infiltration field of claim 15 wherein the first permeable form is sized and shaped to be stackable within the second permeable form.

18. The water infiltration field of claim 11 wherein the upright orientation is vertical.

19. The water infiltration field of claim 11 wherein the upright orientation is not vertical.

20. The water infiltration field of claim 11 wherein the first, second, and third sides are metal and wherein the fourth, fifth, and sixth sides define a u-shape.
